(19) United States
(12) Patent Application Publication
(10) Pub. No.: US 2011/0052818 A1
(43) Pub. Date: Mar. 3, 2011

(54) COATED PAPER FOR INKJET PRINTING, COMPOSITION AND METHOD FOR INKJET PRINTING

(76) Inventors: Douglas Lowell Osterberg, Menasha, WI (US); Brett Jon Fenske, Appleton, WI (US)

(21) Appl. No.: 12/861,267

(22) Filed: Aug. 23, 2010

Related U.S. Application Data
(60) Provisional application No. 61/237,918, filed on Aug. 28, 2009.

(51) Int. Cl. B05D 3/12; B41M 5/40; C09D 11/14; C09D 11/10; B41J 2/015

(52) U.S. Cl. 427/361; 428/32.3; 106/31.71; 524/413; 524/425; 427/364; 347/100; 347/20

(57) ABSTRACT

A coating composition for paper is provided for use with inkjet printing comprising at least one of ground calcium carbonate and kaolin clay, a binder, and a salt suitable to fix the ink on the paper. A method of printing on a paper coated with the composition, as well as the coated paper, and a method of forming the coated paper are also provided.

This application claims priority pursuant to 35 U.S.C. 119(e) of U.S. provisional application No. 61/237,918, filed Aug. 28, 2009, the entire contents of which are hereby incorporated by reference in their entirety.

### BACKGROUND OF THE INVENTION

The present invention is directed to an improved paper coating composition for use in connection with coated paper for inkjet printing.

Gravure, flexography, and offset lithography have been the predominant methods for printing magazines, newspaper inserts, direct mail, and many other forms of printed communication and advertising. Books have predominantly been printed using offset lithography, including educational textbooks.

Gravure, flexography, and offset lithography each require significant set-up costs for printing, resulting in typical printing jobs reaching at least hundreds but more often thousands or tens of thousands of individual print signatures to spread the set-up costs across the volume printed. In addition, each printed signature from these printing processes is identical to each other, unless additional set-up changes are incurred. Typically, a “make ready” loss of material (mainly ink and paper) and press time is incurred when starting up a printing job on these traditional printing operations.

New forms of printing have evolved over the past two decades or so that include various toner or inkjet technologies that afford variable data from signature to signature. In other words, each successive print from these printers can be distinctly different from the previous print. Thus, while still somewhat more costly in large volumes, these variable data or “digital” technologies offer competitive or even lower costs for small volume printing jobs, since their set-up costs are essentially non-existent between different printed forms. The quality of the printing from these technologies has also become competitive with gravure, flexography, and offset lithography.

There are many applications in printing where variable data is useful. Examples include simple name and address changes on a mailing piece, different printed images targeted toward mail recipients' interests for enhanced advertising effect, regional editions of magazines or advertisements, and so on.

In book printing, particularly textbook printing, it is common to print extra copies that are retained for possible future use or sale. It is common to first secure small volumes of promotional copies while necessarily running a reasonable volume on an offset press, resulting in extra copies being held until sales are made. Later, when larger orders are produced, extra copies are held to avoid additional, repeated printing jobs when books are damaged or worn and need to be replaced.

The toner or inkjet based variable data printing solutions overcome the need to print large quantities and extra copies of the same forms or books, or they allow each individual print or book to be unique. In doing so, they offer new business solutions to publishers and printers who seek to deliver added value to their clients through targeted advertising or through reduced overruns and inventory carrying costs.

### SUMMARY OF THE PRESENT INVENTION

The present invention is accordingly directed to a coating composition for paper used in inkjet printing, comprising in major proportion by weight, one or both of ground calcium carbonate or kaolin clay; in minor proportion by weight a binder, and in minor proportion by weight a salt of Group II, III or a transition metal to fix ink pigment. The present invention is also directed to a paper substrate coated with the coating composition, a method of inkjet printing on the coated paper substrate, as well as a method of coating a paper substrate with the coating composition.

### DETAILED DESCRIPTION OF THE INVENTION

The present invention relates to commercial printing, such as direct mail, transpromo (transactional/promotional) billing statements or promotional advertising, etc., and including book printing, and in particular, textbook printing. Each type of printing has its own printing requirements, including different types of paper (matte vs. glossy, for instance), as well as printed image quality and physical durability.

Recent developments in commercial inkjet printing technology include delivering web (roll-fed) printing presses that are achieving printing speeds approaching the low end of offset lithographic printing. Corresponding sheet-fed presses are available also with similar printing technology. In each case, this development is allowing printing speeds and efficiencies to also approach offset lithography. While limited by somewhat higher material costs for ink and paper substrates, the avoidance of high set-up costs and material losses and the additional benefit of variable data are allowing these new printing presses to compete with the traditional printing methods.

Inkjet printing presses, however, require a specially treated substrate to achieve high quality printing that meets the requirements of the various markets targeted for their application. In particular, these substrates must absorb the liquid vehicle, which is principally water, from the inkjet inks in order to dry the inks satisfactorily. The highest quality of these substrates were historically made with surface coatings that used polymer films with reactive resins or, alternatively, very small particle sized, absorbent pigments (typically of silica or precipitated calcium carbonate) along with cationic materials to precipitate or bond the ink to the substrate. These materials and their corresponding manufacturing processes are expensive when compared to traditional coated offset paper coating materials, and this added cost has restricted the application of variable data inkjet printing vs. gravure, flexography, or offset lithography.

In particular, many traditional printing jobs are done on coated glossy substrates. No. 2 or No. 3 coated gloss grades typically have measured 75 degree gloss levels of 60-70% or higher, which is difficult to achieve with less expensive inkjet compatible coating materials. Inkjet printing requires highly absorptive surfaces to wick the liquid water from the ink pigments or dyes that must stay at the substrate surface, and typical calendering processes that buff or polish traditional coated paper surfaces to high gloss levels seal off the surfaces and lessen their absorbency. This is acceptable for traditional printing methods but not for inkjet printing.

Thus, the ability to achieve high gloss in coated paper while maintaining absorbency is novel while doing so without specific, highly absorptive coating pigments like silica, colloidal silica, or precipitated calcium carbonate. Furthermore, it is novel to achieve acceptable absorbency for inkjet printing on coated papers with lower gloss, such as those typically referred to as matte, dull, or silk, without also using high levels of these same, highly absorptive coating pigments.

The present invention may also be advantageously employed with books or other applications requiring special physical capabilities. Coated book printing has unique requirements related to physical characteristics of the paper and to durability of the printed pages and books. It is almost exclusively matte finish, generally light weight (50# text or less usually), and must meet specific requirements for PPI (pages per inch). It also must withstand repeated use, and abuse, over extended periods (semesters, school years, and multiples thereof).

Beside the obvious physical integrity books must maintain over time, there are durability issues associated with the printed surface that are unique to this and other market segments. In particular, it is unacceptable for the printed (inked) surface to scuff off when pages rub against each other, as when opening a book or flipping through its pages. It is also unacceptable for spilled liquids, such as water, soda, coffee, etc. to dissolve the printed image, and it is unacceptable for the inks to smear when a translucent ink pen is used to identify and highlight any text or printed images.

Whether for textbook printing or other printing applications, printed image and ink durability is notably a function of the ink itself, how well it is dried and/or cured, and its ability to resist physical wear or chemical attack. It is also, however, influenced by the paper substrate it is printed onto, which may affect the drying rate of the printed inks. Also, physical scuffing or abrasion of the ink may be affected by the roughness and coefficient of friction of the unprinted paper surface that a printed image might rub against. Additionally, it can be affected by chemical attack of the paper coating that results in softening of the coating binders and release of the printed image along with some paper coating material.

The base paper and materials comprising a paper coating affect the properties of absorbency (ink drying), abrasiveness, coefficient of friction, and resistance to chemical breakdown. It is known, for example, that high levels of calcium carbonate, calcined clay, or structured kaolin clay may improve a coating's water absorbency, but may adversely influence the abrasiveness and coefficient of friction. It is therefore desirable to formulate an inkjet coating without high levels of these materials.

Likewise, traditional inkjet coatings have used high levels of water soluble binders, most commonly polyvinyl alcohol or polyvinyl acetate, to not only bond the coating pigments together but also to swell and absorb water imposed thereon by printing of inkjet inks.

It is therefore desirable to formulate an inkjet coating with little to none of these or other water soluble binder materials, and if necessary to use them, then to also use insolubilizers or cross-linkers to negate their ability to swell and absorb water from the printing of inkjet inks, which would soften and weaken their bonding effect. Other, non-water soluble binder materials, such as SBR or SBA latex, work successfully in formulating coatings suitable for inkjet printing. Their binding mechanism is to physically and/or chemically bond the coating pigments to the base paper surface, but to do so without the ability to absorb water from the printing of inkjet inks, the latter function to be served by the coating void volume, pigmentation, and structuring of the coating and base paper themselves.

These problems may be overcome by using an inkjet-compatible coated web paper intended for book printing or other printing that meets physical strength and PPI requirements as discussed below, wherein the coating contains at least (1) one or more of ground calcium carbonate or kaolin clay, (2) a binder, and (3) a salt of Group II, III or a transition metal to fix the ink pigment(s) on the coating. The coating (based on dry weight) will contain the ground calcium carbonate and/or kaolin clay in major proportion, and the binder and salt in minor proportion.

By the term major proportion it is intended that at least 50% by weight of the coating comprises ground calcium carbonate and/or kaolin clay. By the term minor proportion it is intended that no more than 25% by weight of the coating comprises the noted component of the coating.

By way of additional components that may optionally be present in the coating, there may be present one or more of the following components: calcined clay, coating binder insolubilizer, precipitated calcium carbonate, and/or silica pigment, among other conventional paper coating components.

The ground calcium carbonate component typically has a fineness or size in the range of at least 60% less than 2 microns, and is present in the coating in an amount up to 70% by weight, particularly within a range of from 25 to 50% by weight.

The kaolin clay is present in the coating in an amount up to 80% by weight, particularly within a range of from 15 to 60% by weight.

Salts of Groups II and III of the Periodic Table, or transition metals, are generally present in the coating in an amount within the range of 5 to 15%, typically 10-15% by weight, based on the dry coating weight on the paper substrate. Exemplary salts include but are not limited to magnesium sulfate, magnesium chloride, aluminum chloride, calcium chloride, or potassium chloride.

The identity of the binder which is employed is not critical, and can readily be determined by one of ordinary skill in the art. For instance, the binder may be a latex binder, a polyvinyl alcohol binder, a polyvinyl acetate binder, or a starch binder, among others. The identity of the latex binder is not critical, but generally the latex binder may be described as having the following composition: styrene butadiene, styrene acrylic, or combinations thereof. The latex binder is generally present in the coating in an amount of less than 15% by weight. Polyvinyl alcohol and polyvinyl acetate binder are each generally present in the coating in an amount of less than 7% by weight. The starch binder component is present in an amount of less than 40% by weight.

Combinations of different binders may also be employed if chemically compatible in the coating composition.

The calcined clay is optionally present in the coating in an amount of less than 50% by weight.

Coating binder insolubilizers include, by way of example, glyoxals, ammonium zirconium carbonate, potassium zirconium carbonate, or others, and optionally may be present in the coating in an amount within the range of 0 to 4% by weight.

Plastic pigments may also be present in the coating for use in glossy coatings, and by way of example, may be polystyrene solid bead or hollow-sphere or hollow-sphere perforated or other material composition. The plastic pigment may be present in an amount of less than 20% by weight, preferably 10% by weight or less, and most preferably 5% by weight or less. In some applications, typically for non-glossy coatings, it may not be present at all.

Precipitated calcium carbonate may optionally be present in the coating in an amount of less than 20% by weight, preferably 10% by weight or less, and most preferably 5% by weight or less. Silica, in colloidal or pigment form, may be present in the coating in an amount of 20% by weight or less, preferably 10% by weight or less, and most preferably 5% by weight or less. Such amounts are far less than the greater than 50% by weight that might have normally been employed in prior art paper coating compositions, which is a clear advantage from the standpoint of cost and ease of use of the coating composition of the present invention.

The paper may optionally be calendered to achieve a targeted gloss and smoothness levels typically recognized in publishing and printing markets as having matte, dull, or gloss finishes. Sometimes other terms are used. Such papers generally are defined by the following gloss levels, measured at 75 degrees using TAPPI Test Method T-480: matte (<30), dull (30-50), gloss (55 or higher).

The coated paper will have acceptable water absorbency for inkjet printing without using high levels of expensive silicas, colloidal silicas, or precipitated calcium carbonate materials in the coating composition. Conventional methods may be used to coat the paper with the coating(s) of the present invention. Such methods include but are not limited to blade, rod, curtain, air-knife, gravure, HSM, film-press, size press, or any other. It is contemplated that the paper will be coated on both sides, as both sides of the paper will generally be available for printing. For purposes of coating, the coating composition is applied in the form of an aqueous composition, with the solids content of the slurry varying depending upon the manner of application, as can be readily determined by one of ordinary skill in the art.

Typically, the coat weight of the coating of the present invention on the paper ranges from about 5 to about 20% by weight, with both sides of the paper being coated, based on the total weight of the coated paper substrate. Coating solids are typically 30-70% by weight of the aqueous coating composition, preferably 40-65%, dependent on the coating materials, coat weight desired, and type of applicator. Once applied, the coated paper will be dried under conventional conditions, including but not limited to infrared, air flotation, air impingement, or drying cylinders.

### EXAMPLES

By way of example, several formulations of paper coating compositions are made in accordance with the teachings of the present invention, and identified in the following Tables:

TABLE 1
Example Coating Formula for Lightweight Matte Inkjet Paper

| | |
|---|---|
| Ground Calcium Carbonate | 45.2% |
| Kaolin Clay | 15.2% |
| Calcined Clay | 15.2% |
| Latex | 11% |
| Salt of Group II metal | 11.5% |
| Dispersant | 0.1% |
| Rheology modifier | 0.8% |
| Defoamer | 1.0% |

TABLE 2
Example of Coating Formula for Glossy Inkjet Paper

| | |
|---|---|
| Ground Calcium Carbonate | 40% |
| Kaolin Clay | 16% |
| Calcined Clay | 16% |
| Plastic Pigment | 8% |
| Latex | 3.4% |
| Polyvinyl Alcohol | 3.4% |
| Salt of Group II metal | 12% |
| Dispersant | 0.2% |
| Defoamer | 1.0% |

1-50. (canceled)

51. A coating composition for paper used in inkjet printing, comprising:
in major proportion by weight, one or both of ground calcium carbonate or kaolin clay;
in minor proportion by weight at least one binder, and
in minor proportion by weight a salt of Group II, III or a transition metal to fix ink pigment.

52. The coating composition of claim 51, optionally containing one or more of calcined clay, coating binder insolubilizers, precipitated calcium carbonate, and silica pigment.

53. The coating composition of claim 51, further containing plastic pigments.

54. The coating composition of claim 51, wherein said at least one binder comprises a latex binder.

55. The coating composition of claim 51, wherein said at least one binder comprises a polyvinyl alcohol, polyvinyl acetate, or starch binder.

56. The coating composition of claim 53, wherein the plastic pigments comprise 20% or less by weight.

57. The coating composition of claim 52, wherein the precipitated calcium carbonate comprises 20% or less by weight.

58. The coating composition of claim 52, wherein the silica comprises 20% or less by weight.

59. The coating composition of claim 51, wherein said ground calcium carbonate is present in an amount within the range of from 0 to 70% by weight.

60. The coating composition of claim 51, wherein said kaolin clay is present in an amount within the range of from 0 to 80% by weight.

61. The coating composition of claim 51, wherein said at least one binder is present in an amount within the range of from 5 to 15% by weight.

62. The coating composition of claim 51, wherein said salt is present in an amount within the range of from 5 to 15% by weight.

63. The coating composition of claim 51, comprising an aqueous formulation suitable for being applied to a paper substrate.

64. A coated paper for use in inkjet printing, comprising:
a paper substrate; and
a coating thereon comprising in major proportion by weight, one or both of ground calcium carbonate or kaolin clay;
in minor proportion by weight at least one binder, and
in minor proportion by weight a salt of Group II, III or a transition metal to fix ink pigment.

65. The coated paper of claim 64, optionally containing one or more of calcined clay, coating binder insolubilizers, precipitated calcium carbonate, and silica pigment.

66. The coated paper of claim 64, wherein said coating contains plastic pigments.

67. The coated paper of claim 66, comprising plastic pigments in said coating in an amount of 20% or less by weight.

68. The coated paper of claim 64, wherein said at least one binder comprises a latex binder.

69. The coated paper of claim 64, wherein said at least one binder comprises a polyvinyl alcohol, polyvinyl acetate, or starch binder.

70. The coated paper of claim 64, wherein said ground calcium carbonate is present in an amount of from 0 to 70% by weight.

71. The coated paper of claim 64, wherein said kaolin clay is present in an amount of from 0 to 80% by weight.

72. The coated paper of claim 65, wherein precipitated calcium carbonate comprises 20% or less by weight of said coating.

73. The coated paper of claim 65, wherein silica comprises 20% or less by weight of said coating.

74. The coated paper of claim 64, wherein said at least one binder is present in an amount within the range of from 5 to 15% by weight.

75. The coated paper of claim 64, wherein said salt is present in an amount within the range of 5 to 15% by weight.

76. The coated paper of claim 64, wherein said coated paper is calendered.

77. A method of inkjet printing, comprising
providing a coated paper having a coating thereon comprising in major proportion by weight, one or both of ground calcium carbonate or kaolin clay, in minor proportion by weight at least one binder, and in minor proportion by weight a salt of Group II, III or a transition metal to fix ink pigment, and
printing on said coated paper using an ink jet printer.

78. The method of inkjet printing of claim 77, said coating optionally containing one or more of calcined clay, coating binder insolubilizers, precipitated calcium carbonate, and silica pigment.

79. The method of inkjet printing of claim 77, said coating further containing plastic pigments.

80. The method of inkjet printing of claim 77, wherein said at least one binder comprises a latex binder.

81. The method of inkjet printing of claim 77, wherein said at least one binder comprises a polyvinyl alcohol, polyvinyl acetate, or starch binder.

82. The method of inkjet printing of claim 79, wherein the plastic pigments comprise 20% or less by weight.

83. The method of inkjet printing of claim 78, wherein the precipitated calcium carbonate comprises 20% or less by weight.

84. The method of inkjet printing of claim 78, wherein the silica comprises 20% or less by weight.

85. The method of inkjet printing of claim 77, wherein said ground calcium carbonate is present in an amount within the range of from 0 to 70% by weight.

86. The method of inkjet printing of claim 77, wherein said kaolin clay is present in an amount within the range of from 0 to 80% by weight.

87. The method of inkjet printing of claim 77, wherein said at least one binder is present in an amount within the range of from 5 to 15% by weight.

88. The method of inkjet printing of claim 77, wherein said salt is present in an amount within the range of from 5 to 15% by weight.

89. A method of forming a coated paper substrate suitable for use as an inkjet printing substrate, said method comprising the steps of:
(1) providing a paper substrate;
(2) forming a coating on at least one side of said paper substrate, said coating comprising in major proportion by weight, one or both of ground calcium carbonate or kaolin clay, in minor proportion by weight at least one binder, and in minor proportion by weight a salt of Group II, III or a transition metal to fix ink pigment; and
(3) optionally, calendering said coated paper.

90. The method of forming a coated paper substrate of claim 89, said coating optionally containing one or more of calcined clay, coating binder insolubilizers, precipitated calcium carbonate, and silica pigment.

91. The method of forming a coated paper substrate of claim 89, said coating further containing plastic pigments.

92. The method of forming a coated paper substrate of claim 89, wherein said at least one binder comprises a latex binder.

93. The method of forming a coated paper substrate of claim 89, wherein said at least one binder comprises a polyvinyl alcohol, polyvinyl acetate, or starch binder.

94. The method of forming a coated paper substrate of claim 91, wherein the plastic pigments comprise 20% or less by weight.

95. The method of forming a coated paper substrate of claim 90, wherein the precipitated calcium carbonate comprises 20% or less by weight.

96. The method of forming a coated paper substrate of claim 90, wherein the silica comprises 20% or less by weight.

97. The method of forming a coated paper substrate of claim 89, wherein said ground calcium carbonate is present in an amount within the range of from 0 to 70% by weight.

98. The method of forming a coated paper substrate of claim 89, wherein said kaolin clay is present in an amount within the range of from 0 to 80% by weight.

99. The method of forming a coated paper substrate of claim 89, wherein said at least one binder is present in an amount within the range of from 5 to 15% by weight.

100. The method of forming a coated paper substrate of claim 89, wherein said salt is present in an amount within the range of from 5 to 15% by weight.
